(19) United States
(12) Patent Application Publication
(10) Pub. No.: US 2023/0212072 A1
(43) Pub. Date: Jul. 6, 2023

(54) PARTIALLY PROTONATED ALKANOLAMINE COMPOSITION, AND USE IN A MILL

(71) Applicant: CHRYSO, ISSY LES MOULINEAUX (FR)

(72) Inventors: Marie JACHIET, Etampes (FR); Bruno PELLERIN, Avon (FR)

(21) Appl. No.: 17/995,637

(22) PCT Filed: Apr. 8, 2021
(86) PCT No.: PCT/EP2021/059175

§ 371 Date: Oct. 6, 2022

(30) Foreign Application Priority Data
Apr. 9, 2020 (FR) 2003563

(51) Int. Cl. C04B 24/12; C04B 22/08; C04B 28/02

(52) U.S. Cl. CPC C04B 24/122; C04B 22/082; C04B 28/02; C04B 2103/52

(57) ABSTRACT

The invention relates to a composition (C) comprising from 10 to 99 wt. % secondary or tertiary alkanolamine (A) in the form of a salt, preferably an inorganic acid salt, and from 1 to 90 wt. % of non-salified alkanolamine (A).

The present invention concerns partially protonated alkanolamine compositions and use thereof in grinding processes, particularly in grinding processes of hydraulic binder and of clinker in particular.

It is known to use alkanolamines when grinding clinker. Alkanolamines are also known to enhance the compressive strengths of cement-based hydraulic compositions.

It has therefore been proposed to combine these effects and to use alkanolamines when grinding hydraulic binder, cement in particular, to benefit from the grinding aid properties of alkanolamines while adding active substances to the hydraulic binder which provide enhanced compressive strength when preparing hydraulic binder compositions.

However, some alkanolamines used when grinding and in particular triisopropanolamine (TIPA), undergo temperature degradation and are therefore no longer available to take part in obtaining good compressive strength when preparing hydraulic binder compositions. To overcome this problem, it has been envisaged to apply a greater quantity of alkanolamine to compensate for degradation thereof. However, the increased concentration of alkanolamine in some mills translates as excessive grinding efficacy and excessive flowability of the cement powder leading to emptying of the mill which is not desirable.

The use of AMP (2-amino-2-methyl-propanol), is also known from FR 3 002 162 particularly in the form of an organic salt when grinding clinker. However, this results in increased flowability of the cement and hence insufficient grinding of the clinker.

It would therefore be advantageous to provide a method allowing the use alkanolamines when grinding a hydraulic binder, cement in particular, while preventing degradation of grinding conditions in particular by not emptying (or draining) the mill.

It would also be advantageous to provide a composition of partially protonated alkanolamines able to be used as grinding agent. There would be a further advantage in providing said method which allows a reduction in the flowability of the hydraulic binder and thereby increases residence time in the mill to obtain a finer powder, but which also allows the obtaining of good compressive strength.

It would also be advantageous to provide a method which, at the grinding step of the hydraulic binder, contributes the compounds needed to improve compressive strength properties, in particular 28-day compressive strength of hydraulic binder compositions, while not degrading grinding conditions in particular by not leading to emptying of the mill.

It is therefore one object of the present invention to provide a composition of alkanolamines able to be used in a grinding process.

Another object of the invention is to provide a method allowing stabilisation of the alkanolamines used in a mill.

A further object of the invention is to provide said method which, at the same time, allows maintaining of the impact on enhanced compressive strength, particularly at 28-days, of the hydraulic binder compositions.

A further object of the present invention is to provide means allowing control over the grinding aid performance of alkanolamines while maintaining properties of enhanced compressive strength, particularly 28-day strength, when preparing hydraulic binder compositions. The object of the present invention is particularly advantageous in all situations not requiring high grinding performance (type of clinker, co-grinding of clinker with soft materials—e.g. limestone filler, natural pozzolana, calcined clays—, low performance mills, open mills without separation system, close grinding systems e.g. with constant airflow separators, cement transfer method via inclined conveyor belt, open bucket elevators, low-performance dust filters or close to saturation (high differential pressure, worn bag filters)).

The object of the present invention is particularly advantageous when co-grinding clinker and limestone to produce CEM II/A or CEM II/B LL which, for enhanced 28-day compressive strength, require high amine dosages (e.g. 120 g of triisopropanolamine (TIPA) per tonne of cement). When such dosages are used in some facilities, rapid emptying of the mill is observed as well as critical dust emission phenomena at the mill outlet and at the elevator.

Surprisingly, it has been observed that the use of amines in salt form provides control over the grinding aid performance of amines, while maintaining full performance with regard to enhancing of 28-day compressive strength.

All these objects are met by the present invention which pertains to a composition (C) comprising, or preferably consisting of, from 10 to 99 weight % secondary or tertiary alkanolamine (A) in the form of a salt, preferably an inorganic acid salt, and from 1 to 90 weight % of non-salified alkanolamine (A).

Preferably, composition (C) comprises, or is preferably consisting of, from 50 to 99 secondary or tertiary alkanolamine (A) in the form of a salt, preferably an inorganic acid salt, and from 1 to 50 weight % of non-salified alkanolamine (A).

The present invention also concerns a method of using alkanolamine (A), preferably secondary or tertiary alkanolamine, for grinding at least one hydraulic binder, preferably cement, comprising:
placing alkanolamine (A) in partially salified form, preferably by means of an inorganic acid, to obtain a composition (C);
adding composition (C) to a mill.

The method preferably further comprises the grinding of said hydraulic binder.

Preferably, the present invention concerns a method of using secondary of tertiary alkanolamine (A) for grinding at least one hydraulic binder, comprising:
placing alkanolamine (A) in partially salified form, by means of an inorganic acid, to obtain a composition (C);
adding composition (C) to a mill.

The method preferably further comprises the grinding of said hydraulic binder.

In composition (C), the alkanolamine (A) in salt form and the non-salified alkanolamine (A) can be different, preferably alkanolamine (A) in salt form and the non-salified alkanolamine (A) are the same.

Preferably, alkanolamine (A) is an alkanolamine of formula (I) N(R¹OH)(R²)(R³) (I) where the R¹, the same or different, are a linear or branched alkyl group having 1 to 10 carbon atoms, preferably 1 to 5 carbon atoms, R² is H or R¹—OH group, R³ is H, a linear or branched alkyl group having 1 to 10 carbon atoms, preferably 1 to 5 carbon atoms, a group R⁴—OH where R⁴ is a linear or branched alkyl group having 1 to 10 carbon atoms, preferably 1 to 5 carbon atoms, or an (alkyl) —N(alkyl-OH)₂ group, the alkyl being linear or branched and having 1 to 5 carbon atoms, preferably (CH₂—CH₂)—N(CH₂—CH₂—OH)₂, at least one of R² and R³ differing from H.

Preferably, alkanolamine (A) is an alkanolamine of formula (I) N(R¹OH)(R¹OH)(R³) (I) where the R¹, the same or different, are a linear or branched alkyl group having 1 to 10 carbon atoms, preferably 1 to 5 carbon atoms, R³ is H, a linear or branched alkyl group having 1 to 10 carbon atoms, preferably 1 to 5 carbon atoms, a group R⁴—OH where R⁴ is a linear or branched alkyl group having 1 to 10 carbon atoms, preferably 1 to 5 carbon atoms.

The method of the invention does not cover the use of acetic acid salts. The method of the invention does no cover the use of AMP (2-amino-2-methyl-propanol).

The present invention also concerns a method of enhancing the compressive strength of a hydraulic binder composition, comprising the use of a composition (C) when grinding the hydraulic binder. In particularly advantageous manner, the method allows enhancing of the compressive strength of the hydraulic binder composition without affecting the grinding performance of the hydraulic binder and of clinker in particular.

Preferably, in the invention when reference is made to compressive strengths, these are preferably 28-day compressive strengths.

The inorganic salts of alkanolamine (A), particularly of formula (I) alkanolamine, are selected from among halide acid salts, the salts of sulfuric acid, phosphoric acid, phosphonic acid, or hydrogensulfate, carbonate or hydrogencarbonate salts.

Preferably, the alkanolamine salt is a salt of sulfuric acid, of phosphoric acid or phosphonic acid, preferably of sulfuric acid.

Preferably, the alkanolamine salt is a halide acid salt or sulfuric acid salt. In particular a hydrochloric acid salt.

The method of the present invention can be applied to any type of alkanolamine (A), preferably secondary or tertiary, preferably of formula (I), in particular to any type of secondary or tertiary alkanolamine (A) of formula (I) used in mills, in particular in clinker and hydraulic binder mills. More particularly, mention can be made of triisopropanolamine (TIPA), diisopropanolamine (DIPA), diethanol-isopropanolamine (DEIPA), ethanol-diisopropanolamine (EDIPA), N,N,N′,N′-tetrakis(2-hydroxyethyl)ethylenediamine (THEED) and methyldiethanolamine (MDEA). Preferably, the alkanolamine is selected from among triisopropanolamine (TIPA), diethanol-isopropanolamine (DEIPA) and ethanol-diisopropanolamine (EDIPA). Preferably, the alkanolamine is triisopropanolamine (TIPA).

The preparation of composition (C) is obtained by mixing the alkanolamine (A) and acid with excess alkanolamine such that the ratio between the number of moles of acid and the number of protons of the acid is lower than the ratio between the number of moles of amines and the number of nitrogen functions in the amine. Since the reaction can be exothermal, it may be necessary to cool the medium during the reaction. On this account, the synthesis of composition (C) is preferably conducted in a glass container immersed in a cold-water bath with continuous measurement of temperature and pH.

The present invention also concerns a method for reducing the flowability of the hydraulic binder in a mill, comprising the use of a composition (C) of the invention when grinding the hydraulic binder.

In the present invention, any type of mill can be used. In particular the invention concerns implementation in vertical mills, ball mills, roller mills, open mills without separation system, closed grinding systems with or without constant airflow separation, processes with cement transfer via inclined conveyor belt, open bucket elevators, low-performance dust filters or close to saturation (high differential pressure, worn bag filters). Preferably, the mill is a ball mill or vertical mill.

The object of the present invention is particularly advantageous when co-grinding clinker and mineral additions to produce CEM II/A or CEM II/B or CEM III which, for enhanced 28-day compressive strengths, require high proportions of amine (e.g. 120 g of TIPA per tonne of cement). When such proportions are used in some facilities, rapid emptying of the mill is observed together with phenomena of critical dust emissions at the mill outlet and at the elevator.

The present invention concerns the grinding of any type of hydraulic binder and in particular of clinker and/or mineral additions.

In the present invention, by the term «hydraulic binder» it is meant any compound having the property of becoming hydrated in the presence of water and the hydration of which allows a solid to be obtained having mechanical characteristics, in particular a cement such as Portland cement, high alumina cement, pozzolanic cement or an anhydrous or semi-hydrated calcium sulfate. The hydraulic binder can be a cement according to standard EN197-1 (2001) and in particular a Portland cement, mineral additions particularly slag additions, or a cement comprising mineral additions.

By «cement» it is meant a cement according to standard EN 197-1 (2001) and in particular a cement of type CEM I, CEM II, CEM III, CEM IV or CEM V according to cement standard NF EN 197-1 (2012). The cement may comprise mineral additions.

The expression «mineral additions» designates slags (such as defined in cement standard NF EN 197-1(2012) paragraph 5.2.2), steelmaking slag, pozzolanic materials (such as defined in cement standard NF EN 197-1(2012) paragraph 5.2.3), fly ash (such as defined in cement standard NF EN 197-1(2012) paragraph 5.2.4), calcined schists (such as defined in cement standard NF EN 197-1 (2012) paragraph 5.2.5), limestones (such as defined in cement standard NF EN 197-1(2012) paragraph 5.2.6) or fumed silicas (such as defined in cement standard NF EN 197-1(2012) paragraph 5.2.7), or mixtures thereof. Other additions, not currently recognized by cement standard NF EN 197-1(2012), can also be used. These are mainly metakaolins, such as A-type metakaolins conforming to standard NF P 18-513 (August 2012) or calcined clays, siliceous additions such as siliceous additions of Qz mineralogy conforming to standard NF P 18-509 (September 2012), alumino-silicates particularly of inorganic geopolymer type.

In particularly advantageous manner, the inventors have shown that the placing in partially salified form of the alkanolamine of the invention allows a reduction in the vapour pressure thereof, thereby protecting it against degradation in the mill particularly due to temperature. The inventors have shown that against all expectations, despite this placing in partially salified form, the alkanolamine maintains it properties of enhancing the mechanical properties of a hydraulic binder composition, in particular properties of enhanced compressive strength in particular 28-day compressive strength. In addition, and surprisingly, the inventors have shown that the placing in partially salified form of an inorganic acid, contrary to known examples in the literature with organic acid salts, allows control over the residence time in the mill and modulated flowability of the hydraulic binder powder.

Therefore, the present invention, in particularly advantageous manner, allows the addition of the alkanolamine without degradation thereof to the grinding process, whilst at the same time improving grinding and maintaining the alkanolamine's capability of enhancing the mechanical properties of hydraulic binder compositions.

Preferably, composition (C) is used at the time of grinding in a content of from 0.003 to 0.025 weight % of hydraulic binder, preferably from 0.005 to 0.015%.

In particularly advantageous manner, composition (C) used at the time of grinding can be used in combination with other additives generally employed in hydraulic compositions or when grinding hydraulic binder, particular mention being made of alkanolamines other than those of formula (I), salts such as sodium chloride, calcium chloride, sodium thiocyanate, calcium thiocyanate, sodium nitrate and calcium nitrate and mixtures thereof, glycols, glycerols, water-reducing additives or high-range water reducers, surfactants, carboxylic acids such as acetic, adipic, gluconic, formic, oxalic, citric, maleic, lactic, tartaric, malonic acids and mixtures thereof.

Composition (C) of the invention can also be used in combination with setting retardants.

In the present invention, among setting retardants particular mention can be made of sugar-, molasses- or vinasse-based retardants.

Preferably, the water-reducing additives and high-range water reducers are selected from among:
sulfonated salts of naphthalene and formaldehyde polycondensates, commonly called polynaphthalene sulfonates or naphthalene-based superplasticizers;
sulfonated salts of melamine and formaldehyde polycondensates, commonly called melamine-based superplasticizers;
lignosulfonates;
sodium gluconate and sodium glucoheptonate;
polyacrylates;
polyarylethers (PAE);
polycarboxylic acid-based products in particular polycarboxylate comb-copolymers which are branched polymers having a main chain carrying carboxylic groups and side chains composed of polyether-type sequences, in particular ethylene polyoxide e.g. poly [(meth)acrylic acid—grafted—ethylene polyoxide]. Superplasticizers in the ranges CHRYSO®Fluid Optima, CHRYSO®Fluid Premia and CHRYSO®Plast Omega marketed by CHRYSO can particularly be used;
products based on polyalkoxylated polyphosphonates described in particular in patent EP 0 663 892 (e.g. CHRYSO®Fluid Optima 100).

In particularly advantageous manner, composition (C) used at the time of grinding can be used in combination with one or more defoamers selected in particular from among ethoxylated fatty amines. The inventors have particularly shown that the use of the alkanolamine in salt form allows a pH range to be obtained allowing solubilisation of ethoxylated fatty amines while maintaining their efficacy in concrete applications in particular which lie within pH ranges in which they become active.

The present invention also concerns a composition comprising:
at least one hydraulic binder;
a composition (C) such as described above.

The composition may further comprise at least one additive such as described above.

The present invention also concerns a hydraulic composition comprising:
water;
at least one hydraulic binder;
a composition (C);
an aggregate.

The hydraulic composition may further comprise at least one additive such as described above.

By «aggregate», it is meant an assembly of mineral grains of mean diameter between 0 and 125 mm. According to their diameter, aggregates are classified under one of the following six families: fillers, ultra-fine sand, sand, gravel-sand mix, fine gravel and ballast (standard XP P 18-545). The most used aggregates are the following:
fillers having a diameter of less than 2 mm and for which at least 85% of aggregates have a diameter of less than 1.25 mm and at least 70% of aggregates have a diameter of less than 0.063 mm;
sands of diameter between 0 and 4 mm (in standard 13-242 possibly having a diameter of up to 6 mm);
gravel-sand mix of diameter greater than 6.3 mm;
fine gravel of diameter between 2 and 63 mm;
sands are therefore included in the definition of aggregate according to the invention;
fillers can particularly be of limestone or dolomitic origin.

The hydraulic composition may also comprise other additives known to skilled persons, e.g. a mineral addition and/or additives for example an air detraining additive, defoamer, setting accelerator or retardant, rheology-modifying agent, other fluidifying agent (plasticizer or superplasticizer), particularly a superplasticizer e.g. CHRYSO®Fluid Premia 180 or CHRYSO®Fluid Premia 196 superplasticizer.

The present invention is now described with the aid of nonlimiting examples.

### EXAMPLE 1

In this example, a mixture is used of triisopropanolamine (TIPA) and a hydrochloric acid salt of triisopropanolamine. It is obtained by mixing triisopropanolamine with different concentrations of hydrochloric acid to obtain TIPA:HCl molar ratios of 1:0.70 and 1:0.85. The molar ratio of amine and acid is therefore non-stoichiometric with excess amine relative to acid, leading to partial protonation of the amine.

To obtain a mixture with a TIPA:HCl molar ratio of 1:0.70, an amount of 156.3 g of triisopropanolamine at a weight concentration of 64% in water is mixed with 36.1 g of 37 weight % hydrochloric acid. Via acid-base reaction between the amine and the acid, 70 weight % of TIPA is converted to hydrochloric acid salt of triisopropanolamine, while 30 weight % of TIPA remains in non-protonated form. Similarly, to obtain a TIPA:HCl molar ratio of 1:0.85, an amount of 156.3 g of triisopropanolamine at a weight concentration of 64% in water is mixed with 43.79 g of 37 weight % hydrochloric acid. Via acid-base reaction between the amine and acid, 85% weight % of TIPA is converted to hydrochloric acid salt of triisopropanolamine, while 15 weight % TIPA remains in non-protonated form.

The two mixtures obtained are in the form of a clear solution. Via back acid-base titration, it is possible to determine the amount of protonated amine (TIPA+HCl) in each mixture. If sodium hydroxide (0.1 mol/L) is added to the mixture of TIPA+HCl and TIPA, a jump in pH is recorded at the equivalence point volume of sodium hydroxide, characteristic of the acidity constant of the chemical compound (TIPA/TIPA+HCl). The volume of sodium hydroxide added up to the equivalence point therefore allows determination of the concentration of the hydrochloric acid salt of triisopropanolamine in the solution.

### EXAMPLE 2

With the same type of chemical reaction, it is possible to prepare a mixture of diethanol-isopropanolamine and hydrochloric acid salt of diethanol-isopropanolamine (DEIPA) at different molar ratios. To obtain a mixture with a DEIPA:HCl molar ratio of 1:0.70, an amount of 117.6 g of diethanol-isopropanolamine at a weight concentration of 85% in water is mixed with 51.8 g of 37 weight % hydrochloric acid. To obtain a mixture with a DEIPA:HCl molar ratio of 1:0.85, an amount of 117.6 g of diethanol-isopropanolamine at a weight concentration of 85% in water, is mixed with 62.9 g of 37 weight % hydrochloric acid. After acid-base reaction, these formulas respectively contain 70 and 85 weight % of diethanol-isopropanolamine in protonated form (DEIPA+HCl). The content of diethanol-isopropanolamine hydrochloric acid salt (DEIPA+HCl) in these mixtures can be confirmed by back acid-base titration with sodium hydroxide.

### EXAMPLE 3

With the same type of chemical reaction, it is possible to prepare a mixture of triisopropanolamine (TIPA) and sulfuric acid salt of triisopropanolamine with a protonation rate of triisopropanolamine lower than 100 weight %. To obtain a solution containing 70 weight % of protonated triisopropanolamine, 117.6 g of triisopropanolamine at a weight concentration of 64% in water are mixed with 18.9 g of 95 weight % sulfuric acid. The formula obtained then contains a mixture of TIPA+H₂SO₄ and TIPA. The protonated amine content of this mixture can again be confirmed by back acid-base titration with sodium hydroxide.

### EXAMPLE 4

On CEM II/A-V 42.5 N cement containing 15 weight % fly ash with target Blaine specific surface area of 4000 cm²/g, a dosage of 90 ppm TIPA allows an 11% increase in cement mill capacity. On the other hand, a dosage of 120 ppm TIPA creates harmful effects by causing excessive flowability of the cement powder which becomes highly volatile. The partially protonated TIPA (TIPA:HCl=1:0.85) in TIPA+HCl form does not have any negative impact on cement grinding (no excessive flowability). It even allows a slight increase in mill capacity and leads to enhanced compressive strengths.

TABLE 1

| | Dosage | Mill capacity | 2-day CS | 28-day CS |
|---|---|---|---|---|
| Description | (ppm) | (tph) | (MPa) | (MPa) |
| Reference | 0 | 70 | 24.0 | 55.2 |
| TIPA | 90 | 78 | 24.5 | 61.3 |
| TIPA | 120 ppm | NA* | — | — |
| TIPA + HCl | 139 ppm** | 80 | 25.2 | 63.0 |
| (TIPA:HCl = | | | | |
| 1:0.85) | | | | |

*Mill emptying
**Equivalent to 120 ppm TIPA + 19 ppm HCl.

This example evidences the fact that in the mill a TIPA content that is too high will impact the efficacy of grinding and leads to a drop in mechanical performance; the placing of TIPA in partial salt form allows these disadvantages to be overcome.

### EXAMPLE 5

In a «half-scale» vertical 2-roller mill, 200 kilograms per hour of CEM I type cement were produced to obtain a cement of target fineness having a Blaine specific surface area of 4000 cm²/g. In the presence of an activator comprising TIPA with different protonation rates, mill performance was monitored (rate of production in kilograms per hour). At a TIPA dosage of 400 ppm, harmful effects of cement excessive flowability can occur since the powder becomes too volatile, which can be monitored by measuring the pressure between the mill filter inlet and outlet.

The addition of 400 ppm non-protonated TIPA to the cement allows mill capacity to be increased in relation to the reference without additive, while maintaining Blaine specific surface area of the cement at the target of 4000 cm²/g. The amine therefore facilitates grinding of the cement and allows an increase in mill performance. Nonetheless, a significant increase in pressure at the filter is recorded compared with the reference without additive. This non-protonated amine promotes dust emissions and the placing in suspension of powder in the mill, which impacts the grinding process. The use of a partially (at 50 weight %) or fully (100 weight %) protonated amine in the form of a hydrochloric acid salt (TIPA+HCl) allows this differential pressure to be reduced. Therefore, the more the rate of protonation of the amine is increased the lesser the dust emissions in the mill. In addition, TIPA+HCl at the two protonation rates allows an increase in mill capacity and in the specific surface area of the cement compared with TIPA, the effect being greater the higher the protonation rate. The use of an amine in the form of a hydrochloric acid salt therefore allows improved mill performance with an effect that can be modulated according to protonation rate. Finally, the mechanical properties of the cement are not modified through the addition of TIPA+HCl at the different protonation rates. At 2-days, the compressive strengths of the cements with additives are equivalent to those of the reference. At 7-days, a slight gain in compressive strength is recorded through the TIPA activating effect, an effect that is seen in its non-protonated form, at 50 weight % protonation and 100 weight % protonation.

| | | | Blaine | Pressure (mBar) | | |
|---|---|---|---|---|---|---|
| | | Mill | specific | at filter | | |
| | Dosage | capacity | surface area | inlet - mill | 2-day CS | 7-day CS |
| Description | (ppm) | (kg/h) | (cm²/g) | outlet | (MPa) | (MPa) |
| Reference | 0 | 178 | 4017 | 2.9 | 35.6 | 51.6 |
| TIPA (0 weight % | 400 | 195 | 3915 | 4.1 | 35.3 | 53.4 |
| TIPA protonation) | | | | | | |
| TIPA + HCl | 438* | 201 | 3937 | 3.8 | 35.7 | 53.1 |
| (50 weight % | | | | | | |
| TIPA protonation) | | | | | | |
| TIPA + HCl | 476** | 211 | 3994 | 3.7 | 34.6 | 52.5 |
| (100 weight % | | | | | | |
| TIPA protonation) | | | | | | |

*Equivalent to 400 ppm TIPA + 38 ppm HCl
**Equivalent to 400 ppm TIPA + 76 ppm HCl.

This example evidences the fact that in the vertical mill, the use of TIPA in partial hydrochloric acid salt form (TIPA+HCl) instead of TIPA, allows grinding efficacy to be improved translating as a reduction in the differential pressure of the filter, an increase in the specific surface area of the cement and an increase in mill capacity. The higher the protonation rate of TIPA by hydrochloric acid, the more this beneficial effect on mill performance is visible. In addition, the mechanical properties of the cement remain equivalent to that of the reference at 2 days and even slightly higher than the reference at 7 days in the presence of TIPA+HCl (at 50 and 100 weight % protonation).

1. A composition (C) comprising from 10 to 99 weight % secondary or tertiary alkanolamine (A) in the form of a salt, and from 1 to 90 weight % of non-salified alkanolamine (A).

2. The composition (C) according to claim 1 comprising from 50 to 99 weight % of secondary or tertiary alkanolamine (A) in the form of a salt, and from 1 to 50 weight % of non-salified alkanolamine (A).

3. The composition according to claim 1, wherein the alkanolamine salt is a halide acid salt, or a salt of sulfuric acid, phosphoric acid, phosphonic acid, or a hydrogensulfate, carbonate or hydrogencarbonate salt.

4. The composition according to claim 1, wherein the alkanolamine salt is a halide acid salt or sulfuric acid salt.

5. The composition according to claim 1, wherein the alkanolamine salt is a hydrochloric acid salt.

6. The composition according to claim 1, wherein the alkanolamine is an alkanolamine of formula (I) N(R¹OH)(R²)(R³) (I) wherein the R¹, the same or different, are a linear or branched alkyl group having 1 to 10 carbon atoms, R² is H or R¹—OH group, R³ is H, a linear or branched alkyl group having 1 to 10 carbon atoms, a R⁴—OH group where R⁴ is a linear or branched alkyl group having 1 to 10 carbon atoms, or an (alkyl)-N(alkyl-OH)₂ group, the alkyl being linear or branched and having 1 to 5 carbon atoms, at least one of R² and R³ differing from H.

7. The composition according to claim 1, wherein the alkanolamine is selected from the group consisting of among triisopropanolamine (TIPA), diisopropanol amine (DIPA), di ethanol-isopropanolamine (DEIPA), ethanol-diisopropanolamine (EDIPA), N,N,N′,N′-tetrakis(2-hydroxyethyl)ethylenediamine (THEED) and methyldiethanolamine (MDEA).

8. The composition according to claim 1, wherein the alkanolamine is selected from the group consisting of triisopropanolamine (TIPA), diethanol-isopropanolamine (DEIPA) and ethanol-diisopropanolamine (EDIPA).

9. The composition according to claim 1, wherein the alkanolamine is triisopropanolamine (TIPA).

10. A method of using a secondary or tertiary alkanolamine for grinding at least one hydraulic binder comprising:
converting the alkanolamine (A) to a partially salified form, to obtain a composition (C) according to claim 1;
adding composition (C) to a mill.

11. (canceled)

12. The method according to claim 10, wherein alkanolamines other than the secondary or tertiary alkanolamine (A) of composition (C), salts of the secondary or tertiary alkanolamine (A) of composition (C), glycols, glycerols, water-reducing additives and high-range water reducers; surfactants, carboxylic acids, and/or setting retardants are used in addition to the alkanolamine salt.

13. The method according to claim 10 wherein one or more defoamers are used in combination with the alkanolamine salt.

14. A composition comprising:
at least one hydraulic binder;
a composition (C) according to claim 1; and
optionally water and aggregates.

15. The composition according to claim 14, further comprising one or more defoamer compounds.

16. The composition according to claim 1, wherein the alkanolamine salt is an inorganic acid salt.

17. The composition according to claim 7, wherein R⁴ is (CH₂—CH₂)—N(CH₂—CH₂—OH)₂.

18. The method according to claim 12, wherein converting the alkanolamine (A) to a partially salified form is by means of an inorganic acid.

19. The method according to claim 14, wherein:
the salts are selected from the group consisting of sodium chloride, calcium chloride, sodium thiocyanate, calcium thiocyanate, sodium nitrate and calcium nitrate and mixtures thereof,
the water-reducing additives and high-range water reducers are selected from the group consisting of sulfonated salts of naphthalene and formaldehyde polycondensates, commonly called polynaphthalene sulfonates or naphthalene-based superplasticizers; sulfonated salts of melamine and formaldehyde polycondensates, commonly called melamine-based superplasticizers; lignosulfonates; sodium gluconate and sodium glucoheptonate; polyacrylates; polyarylethers (PAE); polycarboxylic acid-based products; and products based on polyalkoxylated polyphosphonates,
the carboxylic acids are selected from the group consisting of acetic, adipic, gluconic, formic, oxalic, citric, maleic, lactic, tartaric, and malonic acids, and/or
the setting retardants are chosen from sugar-, molasses- or vinasse-based, and mixtures thereof.

20. The method according to claim 15, wherein the polycarboxylic acid-based products are polycarboxylate comb-copolymers, which are branched polymers having a main chain carrying carboxylic groups and side chains composed of polyether-type sequences.

21. The method according to claim 16, wherein the polycarboxylate comb-copolymers are poly [(meth)acrylic acid—grafted—ethylene polyoxide.
